(19) United States
(12) Patent Application Publication
(10) Pub. No.: US 2013/0162079 A1
(43) Pub. Date: Jun. 27, 2013

(54) SPINDLE MOTOR

(71) Applicants: Yun Yeong Park, Gyunggi-do (KR); Yeol Choi, Gyunggi-do (KR); Young Sun Yoo, Gyunggi-do (KR)

(72) Inventors: Yun Yeong Park, Gyunggi-do (KR); Yeol Choi, Gyunggi-do (KR); Young Sun Yoo, Gyunggi-do (KR)

(73) Assignee: SAMSUNG ELECTRO-MECHANICS CO., LTD., Gyunggi-do (KR)

(21) Appl. No.: 13/408,989

(22) Filed: Feb. 29, 2012

(30) Foreign Application Priority Data
Dec. 22, 2011 (KR) 1020110140301

(51) Int. Cl. H02K 7/08

(52) U.S. Cl. 310/90

(57) ABSTRACT

Disclosed herein is a spindle motor. In the spindle motor according to the present invention, a thrust part is disposed at a lower portion of a shaft, and a support part surface-contacting a lower end of the shaft is formed at the thrust part so as to have a round shape, thereby making it possible to easily prevent a wobble phenomenon of a rotor due to a gap in a shaft system. In addition, a guide part is formed to be protruded at the thrust part to lock the shaft including a narrow part formed therein, thereby making it possible to easily prevent floating of the rotor.

### CROSS REFERENCE TO RELATED APPLICATION

This application claims the benefit of Korean Patent Application No. 10-2011-0140301, filed on Dec. 22, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

A spindle motor may easily maintain rotational characteristics since a shaft rotates while maintaining a predetermined contact section with a bearing. Therefore, the spindle motor has been widely used as a unit for driving a recording medium requiring high speed rotation, such as a hard disk drive (HDD), an optical disk drive (ODD), or the like.

This spindle motor is configured to include an armature, a rotor including a main magnet generating electromagnetic force between the armature and the main magnet, and a stator rotatably supporting the rotor.

In addition, the rotor may include a disk fixing device for fixing a disk of the recording medium and rotate by the electromagnetic force generated between the armature and the main magnet to write data to or reproduce the data from the disk mounted on the disk fixing device.

Meanwhile, in the spindle motor, a shaft system is configured of the shaft and the bearing rotatably supporting the shaft. In addition, since the shaft rotates through sliding movement with the bearing, a gap is formed in the shaft system and a fluid such as oil, or the like, is interposed in the gap to allow the sliding movement to be easily performed.

However, a wobble phenomenon of a rotor may be generated at the time of rotation of the spindle motor due to a gap formed in the shaft system. Furthermore, a lifespan of the spindle motor is reduced due to the wobble phenomenon of the rotor.

### SUMMARY OF THE INVENTION

Therefore, the present invention is to solve a problem that a life span of a spindle motor is reduced due to a wobble phenomenon of a rotor caused by a gap in a shaft system.

The present invention has been made in an effort to provide a spindle motor capable of easily preventing a wobble phenomenon of a rotor due to a gap in a shaft system.

Further, the present invention has been made in an effort to provide a spindle motor capable of easily preventing a wobble phenomenon of a rotor due to a gap in a shaft system and easily preventing floating of the rotor.

According to a preferred embodiment of the present invention, there is provided a spindle motor including: a shaft; a stator including a bearing so as to rotatably support the shaft; an armature including a core provided on the stator; a rotor installed at an upper portion of the shaft and including a main magnet disposed to face the core to generate electromagnetic force; and a thrust part disposed at a lower portion of the shaft and provided with a support part surface-contacting a lower end of the shaft and having a round shape.

The stator may include: a bearing holder including the bearing provided in an inner portion thereof; and a plate including the bearing holder installed on an upper portion thereof, and the thrust part may be formed on the plate.

The stator may include a bearing holder including the bearing provided in an inner portion thereof, and the thrust part may be formed at a lower portion of the bearing holder.

The thrust part may be formed integrally with or separately from the bearing holder.

The stator may further include a plate having the bearing holder installed on an upper portion thereof.

The support part may be formed by processing an upper surface of the thrust part so as to have a round shape.

The support part may be formed so as to have a shape in which it is rounded upwardly or downwardly.

The support part may be formed by providing lubricating oil to an upper portion of the thrust part so as to have a round shape.

The support part may be formed so as to have a shape in which it is rounded upwardly or downwardly.

According to another preferred embodiment of the present invention, there is provided a spindle motor including: a shaft having a narrow part formed at a lower portion thereof; a stator including a bearing so as to rotatably support the shaft and including a bearing holder having the bearing provided in an inner portion thereof; an armature including a core provided on the stator; a rotor installed at an upper portion of the shaft and including a main magnet disposed to face the core to generate electromagnetic force; and a thrust part disposed at a lower portion of the shaft and provided with a support part surface-contacting a lower end of the shaft and having a round shape and a guide part formed to be protruded to thereby be caught and locked by the narrow part.

The stator may include: the bearing holder including the bearing provided in an inner portion thereof; and a plate including the bearing holder installed on an upper portion thereof, and the thrust part may be formed on the plate.

The stator may include the bearing holder including the bearing provided in an inner portion thereof, and the thrust part may be formed at a lower portion of the bearing holder.

The thrust part may be formed integrally with or separately from the bearing holder.

The stator may further include a plate having the bearing holder installed on an upper portion thereof.

The support part may be formed by processing an upper surface of the thrust part so as to have a round shape.

The support part may be formed so as to have a shape in which it is rounded upwardly or downwardly.

The support part may be formed by providing lubricating oil to an upper portion of the thrust part so as to have a round shape.

The support part may be formed so as to have a shape in which it is rounded upwardly or downwardly.

### BRIEF DESCRIPTION OF THE DRAWINGS

FIG. 1 is a cross-sectional view showing a spindle motor including a thrust part provided with a support part according to a preferred embodiment of the present invention;

FIG. 2 is an enlarged cross-sectional view showing a concave of FIG. 1;

FIG. 3 is a cross-sectional view showing a spindle motor including a thrust part provided with a support part according to another preferred embodiment of the present invention;

FIG. 4 is an enlarged cross-sectional view showing a concave of FIG. 3;

FIG. 5 is a cross-sectional view showing a spindle motor including a thrust part provided with a support part and a guide part according to another preferred embodiment of the present invention;

FIG. 6 is an enlarged cross-sectional view showing a concave of FIG. 5;

FIG. 7 is a cross-sectional view showing a spindle motor including a thrust part provided with a support part and a guide part according to another preferred embodiment of the present invention; and

FIG. 8 is an enlarged cross-sectional view showing a concave of FIG. 7.

### DESCRIPTION OF THE PREFERRED EMBODIMENTS

The above and other objects, features and advantages of the present invention will be more clearly understood from preferred embodiments and the following detailed description taken in conjunction with the accompanying drawings. In describing the present invention, a detailed description of related known functions or configurations will be omitted so as not to obscure the gist of the present invention.

Hereinafter, a preferred embodiment of the present invention is described hereafter in detail with reference to the accompanying drawings.

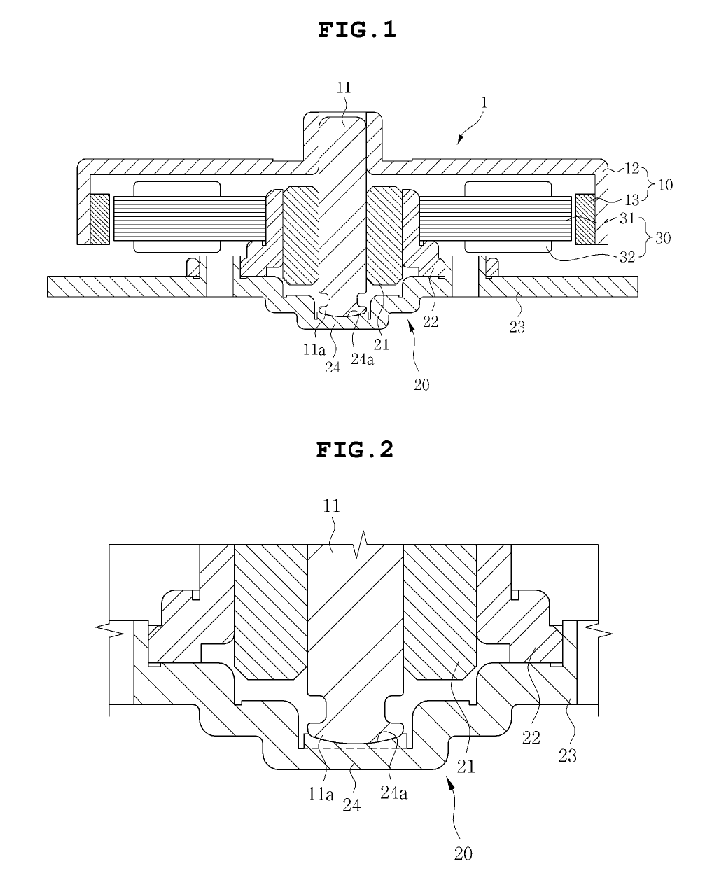

A spindle motor 1 according to a preferred embodiment of the present invention is configured to include a shaft 11, a stator 20 including a bearing 21 so as to rotatably support the shaft 11, an armature 30 including a core provided on the stator 20, a rotor 10 installed at an upper portion of the shaft 11 and including a main magnet disposed to face the core 31 to generate electromagnetic force, and a thrust part 24, as shown in FIG. 1.

The thrust part 24 is disposed at a lower portion of the shaft 11 configuring a shaft system together with the bearing 21 and includes a round shaped support part 24a formed at an upper portion thereof.

Therefore, a lower end 11a of the shaft 11 surface-contacts an upper portion of the support part 24a, thereby preventing a wobble phenomenon of the rotor that is generated since the shaft 11 rotates while being shaken horizontally due to a gap formed in the shaft system.

Here, the rotor 10 includes a rotor case 12 installed at the upper portion of the shaft 11 and the main magnet 13 provided on the rotor case 12 and rotates by the electromagnetic force generated between the main magnet 13 and the core 31. The support part 24a formed at the thrust part 24 and having the round shape surface-contacts and supports the lower end 11a of the shaft 11, thereby making it possible to prevent the wobble phenomenon of the rotor 10.

The thrust part 24 provided with the support part 24a may be formed as follows. That is, as shown in FIGS. 1 and 2, the stator 20 of the spindle motor 1 includes a bearing holder 22 including the bearing 21 provided in an inner portion thereof, and a plate 23 including the bearing holder 22 installed on an upper portion thereof, wherein the thrust part 24 is formed on the plate 23.

The bearing holder 22 has a cylindrical structure and includes the bearing 21 provided in the inner portion thereof. In addition, the core 31 having a coil 32 wound therearound is disposed on an outer portion of the bearing holder 22 to form the armature 30.

The plate 23 has a disk shape and includes the bearing holder 22 installed together with a circuit board on the upper portion thereof, and the thrust part 24 is formed under the bearing 21 provided in the inner portion of the bearing holder 22, such that the thrust part 24 is disposed at the lower portion of the shaft 11.

Here, the thrust part 24 may be formed by downwardly bending the plate 23 multiple times based on the bearing holder 22, which is shown by way of example in the FIGS. 1 and 2.

The support part 24a may be formed by processing the upper portion of this thrust part 24 so as to have a round shape. Alternatively, the support part 24a may be formed by applying and providing solid grease, which is lubricating oil, to the upper portion of the thrust part 24. In this case, it is possible to prevent noise and deterioration of durability due to friction between the lower end 11a of the shaft 11 and the thrust part 24.

Here, the round shape of the support part 24a may be a hemispherical groove shape as shown in FIG. 2. In this case, it is possible to prevent scattering of oil interposed between the shaft 11 and the bearing 21.

In addition, the round shape of the support part 24a may be a hemispherical protrusion shape. The lower end 11a of the shaft 11 is formed to have the same shape as the round shape of the support part 24a.

Therefore, the lower end 11a of the shaft 11 having the same shape as that of the support part 24a formed as described above surface-contacts the upper portion of the support part 24a to prevent shaking of the shaft 11 due to the gap formed in the shaft system, thereby making it possible to prevent the wobble phenomenon of the rotor 10 installed at the upper portion of the shaft 11.

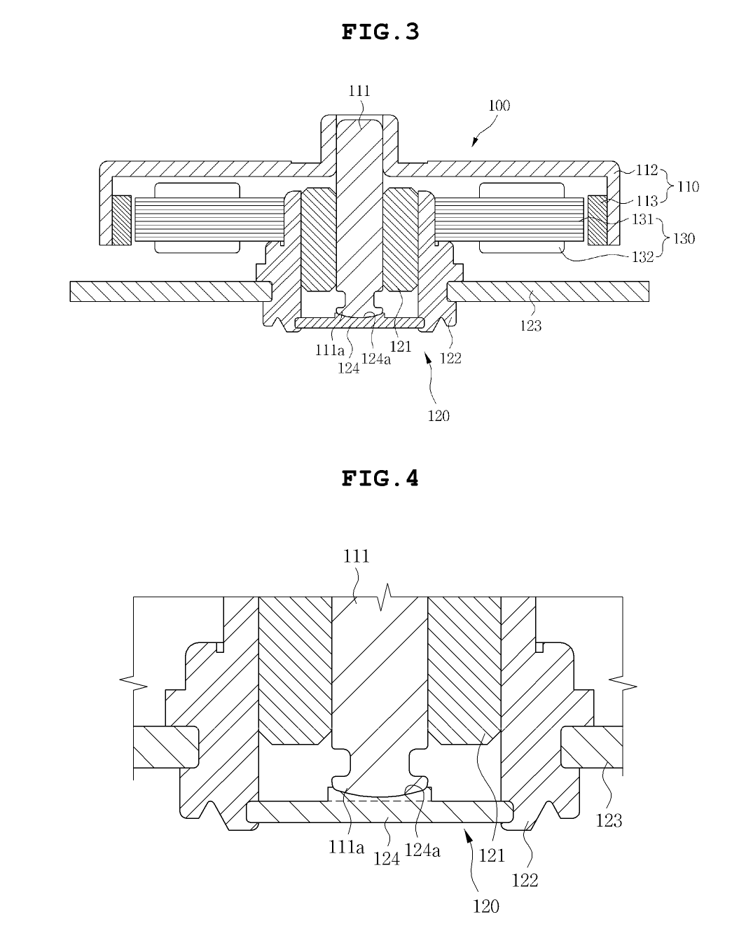

Meanwhile, another example of a thrust part 24 according to the preferred embodiment of the present invention will be described. That is, as shown in FIGS. 3 and 4, a stator 120 of a spindle motor 100 includes a bearing holder 122 including a bearing 121 provided in an inner portion thereof, wherein a thrust part 124 is formed in the bearing holder 122.

The bearing holder 122 has a cylindrical structure and includes the bearing 121 provided in the inner portion thereof. In addition, a core 131 having a coil 132 wound therearound is disposed on an outer portion of the bearing holder 22 to form the armature 130.

Further, the thrust part 124 is formed under the bearing 121, that is, at a lower portion of the bearing 121, provided in the bearing holder 122, such that the thrust part 124 is disposed at the lower portion of the shaft 111.

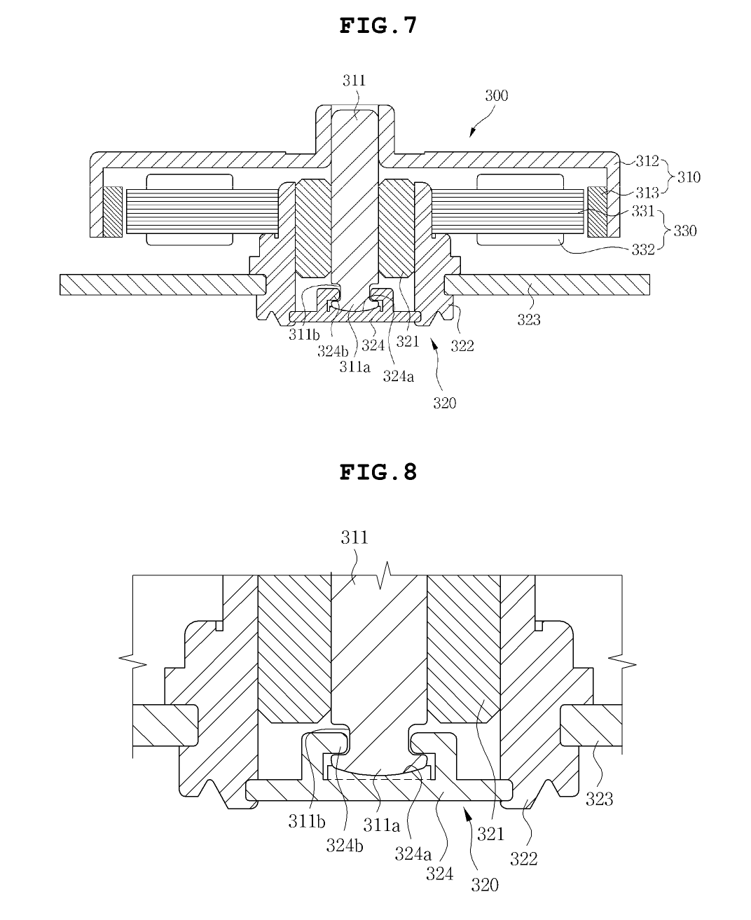

Here, the thrust part 124 may be formed integrally with the bearing holder 122 or separately from the bearing holder 122. FIGS. 7 and 8 show that the thrust part 124 is formed separately from the bearing holder 122 by way of example. This bearing holder 122 is installed at a plate 123 including a circuit board provided on an upper portion thereof.

The support part 124a may be formed by processing an upper portion of the thrust part 124 so as to have a round shape or be formed to have a round shape by applying and providing solid grease, which is lubricating oil, to an upper portion of the thrust part 124. In this case, it is possible to prevent noise and deterioration of durability due to friction between a lower end 111a of the shaft 111 and the thrust part 124.

Here, the round shape of the support part 124a may be a hemispherical groove shape as shown in FIG. 4. In this case, it is possible to prevent scattering of oil interposed between the shaft 111 and the bearing 121. In addition, the round shape of the support part 124a may be a hemispherical protrusion shape. The lower end 111a of the shaft 111 is formed to have the same shape as the round shape of the support part 124a.

Therefore, the lower end 111a of the shaft 111 having the same shape as that of the support part 124a formed as described above surface-contacts the upper portion of the support part 124a to prevent shaking of the shaft 111 due to the gap formed in the shaft system, thereby making it possible to prevent the wobble phenomenon of the rotor 110 including a rotor case 112 installed at the upper portion of the shaft 111 and the main magnet 113.

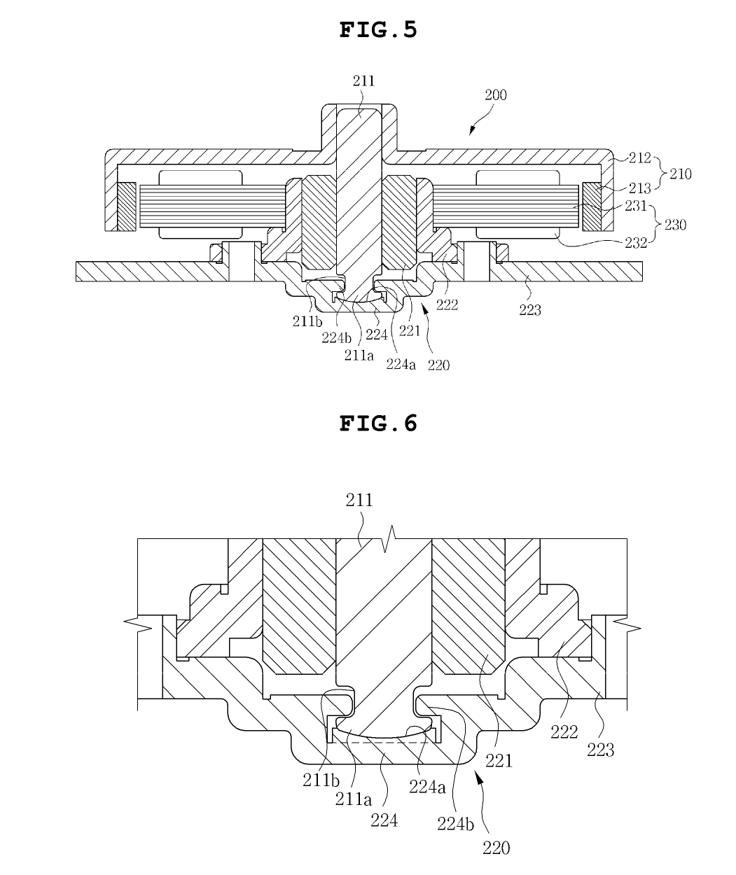

A spindle motor 200 according to another preferred embodiment of the present invention is configured to include a shaft 211 having a narrow part 211b formed at a lower portion thereof, a stator 220 including a bearing 221 so as to rotatably support the shaft 211, an armature 230 including a core provided on the stator 220, a rotor 210 installed at an upper portion of the shaft 211 and including a main magnet disposed to face the core 231 to generate electromagnetic force, and a thrust part 224, as shown in FIG. 5.

The thrust part 224 is disposed at a lower portion of the shaft 211 configuring a shaft system together with the bearing 221 and includes a round shaped support part 224a formed at an upper portion thereof and a guide part 224b formed to be protruded at a side portion thereof, such that the thrust member 224 is caught and locked by the narrow part 211b formed in the shaft 211.

Therefore, a lower end 211a of the shaft 211 surface-contacts an upper portion of the support part 224a, thereby making it possible to prevent a wobble phenomenon of the rotor 210 that is generated since the shaft 211 rotates while being shaken horizontally due to a gap formed in the shaft system and prevent floating of the rotor 210 through the guide part 224b.

Here, the rotor 210 includes a rotor case 212 installed at the upper portion of the shaft 211 and the main magnet 213 provided on the rotor case 212 and rotates by the electromagnetic force generated between the main magnet 213 and the core 231. The support part 224a formed at the thrust part 224 and having the round shape surface-contacts and supports the lower end 211a of the shaft 211, thereby making it possible to prevent the wobble phenomenon of the rotor 210, and the guide part 224b is caught and locked by the narrow part 211b formed in the shaft 211, thereby making it possible to prevent floating of the rotor 210.

The thrust part 224 provided with the support part 224a and the guide part 224b may be formed as follows. That is, as shown in FIGS. 5 and 6, the stator 220 of the spindle motor 200 includes a bearing holder 222 including the bearing 221 provided in an inner portion thereof and a plate 223 including the bearing holder 222 installed on an upper portion thereof, wherein the thrust part 224 is formed on the plate 223.

The bearing holder 222 has a cylindrical structure and includes the bearing 221 provided in the inner portion thereof. In addition, the core 231 having a coil 232 wound therearound is disposed on an outer portion of the bearing holder 222 to form the armature 230.

The plate 223 has a disk shape and includes the bearing holder 222 installed together with a circuit board on the upper portion thereof, and the thrust part 224 is formed under the bearing 221 provided in the inner portion of the bearing holder 222, such that the thrust part 224 is disposed at the lower portion of the shaft 211.

Here, the thrust part 224 may be formed by downwardly bending the plate 223 multiple times based on the bearing holder 222, which is shown by way of example in the FIGS. 5 and 6.

The support part 224a may be formed by processing the upper surface of this thrust part 224 so as to have a round shape, and the guide part 224b may be formed by protruding the side portion of the thrust part 224 toward the shaft 211.

Alternatively, the support part 224a may be formed by applying and providing solid grease, which is lubricating oil, to the upper portion of the thrust part 224. In this case, it is possible to prevent noise and deterioration of durability due to friction between the lower end 211a of the shaft 211 and the thrust part 224.

Here, the round shape of the support part 224a may be a hemispherical groove shape as shown in FIG. 6. In this case, it is possible to prevent scattering of oil interposed between the shaft 211 and the bearing 221.

In addition, the round shape of the support part 224a may be a hemispherical protrusion shape. The lower end 211a of the shaft 211 is formed to have the same shape as the round shape of the support part 224a.

Therefore, the lower end 211a of the shaft 211 having the same shape as that of the support part 224a formed as described above surface-contacts the support part 224a to prevent shaking of the shaft 211 due to the gap formed in the shaft system, thereby making it possible to prevent the wobble phenomenon of the rotor 210 installed at the upper portion of the shaft 211 and prevent floating of the rotor 210 through the guide part 224b.

Meanwhile, another example of a thrust part 24 provided with a support part 324a and a guide part 324b according to the preferred embodiment of the present invention will be described below. That is, as shown in FIGS. 7 and 8, a stator 320 of a spindle motor 300 includes a bearing holder 322 including a bearing 321 provided in an inner portion thereof, wherein a thrust part 324 is formed in the bearing holder 322.

The bearing holder 322 has a cylindrical structure and includes the bearing 321 provided in the inner portion thereof. In addition, a core 331 having a coil 332 wound therearound is disposed on an outer portion of the bearing holder 322 to form the armature 330.

Further, the thrust part 324 is formed under the bearing 321, that is, at a lower portion of the bearing 321, provided in the bearing holder 322, such that the thrust part 324 is disposed at the lower portion of the shaft 311.

Here, the thrust part 324 may be formed integrally with the bearing holder 322 or separately from the bearing holder 322. FIGS. 3 and 4 shows that the thrust part 324 is formed separately from the bearing holder 322 by way of example. This bearing holder 322 is installed at a plate 323 including a circuit board provided on an upper portion thereof.

The support part 324a may be formed by processing the upper surface of the thrust part 324 so as to have a round shape, and the guide part 324b may be formed by protruding the thrust part 324 toward the shaft 311.

Alternatively, the support part 324a may be formed to have a round shape by applying and providing solid grease, which is lubricating oil, to the upper portion of the thrust part 324. In this case, it is possible to prevent noise and deterioration of durability due to friction between the lower end 311a of the shaft 311 and the thrust part 324.

Here, the round shape of the support part 324a may be a hemispherical groove shape as shown in FIG. 8. In this case, it is possible to prevent scattering of oil interposed between the shaft 311 and the bearing 321. In addition, the round shape of the support part 324a may be a hemispherical protrusion shape. The lower end 311a of the shaft 311 is formed to have the same shape as the round shape of the support part 324a.

Therefore, the lower end 311 a of the shaft 311 having the same shape as that of the support part 324a formed as described above surface-contacts the upper portion of the support part 324a to prevent shaking of the shaft 311 due to the gap formed in the shaft system, thereby making it possible to prevent the wobble phenomenon of the rotor 310 including a rotor case 312 installed at the upper portion of the shaft 311 and a main magnet 313 and prevent floating of the rotor 310 through the guide part 324b.

As set forth above, according to the preferred embodiments of the present invention, the support part formed at the thrust part and having a round shape surface-contacts and supports the lower end of the shaft to prevent the shaft from being shaken due to the gap formed between the shaft and the bearing, thereby making it possible to increase a lifespan of the spindle motor.

Meanwhile, the support part formed at the thrust part and having a round shape supports the lower end of the shaft and the guide part is locked by the narrow part formed in the shaft to prevent the rotor from being floated upwardly due to the gap formed between the shaft and the bearing during a process in which the shaft is shaken or rotated, thereby making it possible to increase a lifespan of the spindle motor.

In addition, a stopper, a hook, or the like, according to the prior art that has been used in order to prevent the rotor from being floated is omitted due to the guide part, thereby making it possible to reduce a manufacturing cost and simplify a process.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft;
a stator including a bearing so as to rotatably support the shaft;
an armature including a core provided on the stator;
a rotor installed at an upper portion of the shaft and including a main magnet disposed to face the core to generate electromagnetic force; and
a thrust part disposed at a lower portion of the shaft and provided with a support part surface-contacting a lower end of the shaft and having a round shape.

2. The spindle motor as set forth in claim 1, wherein the stator includes:
a bearing holder including the bearing provided in an inner portion thereof; and
a plate including the bearing holder installed on an upper portion thereof, and
wherein the thrust part is formed on the plate.

3. The spindle motor as set forth in claim 1, wherein the stator includes a bearing holder including the bearing provided in an inner portion thereof, and
wherein the thrust part is formed at a lower portion of the bearing holder.

4. The spindle motor as set forth in claim 3, wherein the thrust part is formed integrally with or separately from the bearing holder.

5. The spindle motor as set forth in claim 4, wherein the stator further includes a plate having the bearing holder installed on an upper portion thereof.

6. The spindle motor as set forth in claim 1, wherein the support part is formed by processing an upper surface of the thrust part so as to have a round shape.

7. The spindle motor as set forth in claim 6, wherein the support part is formed so as to have a shape in which it is rounded upwardly or downwardly.

8. The spindle motor as set forth in claim 1, wherein the support part is formed by providing lubricating oil to an upper portion of the thrust part so as to have a round shape.

9. The spindle motor as set forth in claim 8, wherein the support part is formed so as to have a shape in which it is rounded upwardly or downwardly.

10. A spindle motor comprising:
a shaft having a narrow part formed at a lower portion thereof;
a stator including a bearing so as to rotatably support the shaft and including a bearing holder having the bearing provided in an inner portion thereof;
an armature including a core provided on the stator;
a rotor installed at an upper portion of the shaft and including a main magnet disposed to face the core to generate electromagnetic force; and
a thrust part disposed at a lower portion of the shaft and provided with a support part surface-contacting a lower end of the shaft and having a round shape and a guide part formed to be protruded to thereby be caught and locked by the narrow part.

11. The spindle motor as set forth in claim 10, wherein the stator includes:
the bearing holder including the bearing provided in an inner portion thereof; and
a plate including the bearing holder installed on an upper portion thereof, and
wherein the thrust part is formed on the plate.

12. The spindle motor as set forth in claim 10, wherein the stator includes the bearing holder including the bearing provided in an inner portion thereof, and
wherein the thrust part is formed at a lower portion of the bearing holder.

13. The spindle motor as set forth in claim 12, wherein the thrust part is formed integrally with or separately from the bearing holder.

14. The spindle motor as set forth in claim 13, wherein the stator further includes a plate having the bearing holder installed on an upper portion thereof.

15. The spindle motor as set forth in claim 10, wherein the support part is formed by processing an upper surface of the thrust part so as to have a round shape.

16. The spindle motor as set forth in claim 15, wherein the support part is formed so as to have a shape in which it is rounded upwardly or downwardly.

17. The spindle motor as set forth in claim 10, wherein the support part is formed by providing lubricating oil to an upper portion of the thrust part so as to have a round shape.

18. The spindle motor as set forth in claim 17, wherein the support part is formed so as to have a shape in which it is rounded upwardly or downwardly.
